(19) United States
(12) Patent Application Publication
(10) Pub. No.: US 2025/0247728 A1
(43) Pub. Date: Jul. 31, 2025

(54) SYSTEMS, METHODS, AND DEVICES FOR DETECTING OVERLAPPING MEASUREMENT GAPS

(71) Applicant: Apple Inc., Cupertino, CA (US)

(72) Inventors: Jie Cui, San Jose, CA (US); Yang Tang, San Jose, CA (US); Qiming Li, Beijing (CN); Yushu Zhang, Beijing (CN); Dawei Zhang, Saratoga, CA (US); Manasa Raghavan, Sunnyvale, CA (US); Hong He, San Jose, CA (US); Xiang Chen, Campbell, CA (US)

(21) Appl. No.: 18/856,755

(22) PCT Filed: Apr. 24, 2022
(86) PCT No.: PCT/CN2022/088728

§ 371 Date: Oct. 14, 2024

(51) Int. Cl. H04W 24/10

(52) U.S. Cl. CPC H04W 24/10

(57) ABSTRACT

Systems, methods, and devices are provided for processing potentially overlapping measurement gaps. In one example, a baseband processor of a user equipment (UE), includes one or more processors configured to receive a first measurement gap configuration configuring a first measurement gap and a second measurement gap configuration configuring a second measurement gap. A measurement gap (MG) proximity between the first measurement gap and the second measurement gap is determined and evaluated with respect to a proximity condition. The proximity condition defines a minimum time between measurement gaps. In response to the MG proximity violating the proximity condition, the one or more processors are configured to determine that the first measurement gap and the second measurement gap are overlapping, and in response, select one of the first measurement gap or the second measurement gap for receiving reference signals.

### FIELD

This disclosure relates to wireless communication networks including techniques for wireless synchronization.

### BACKGROUND

As the number of mobile devices within wireless networks, and the demand for mobile data traffic, continue to increase, changes are made to system requirements and architectures to better address current and anticipated demands. For example, some wireless communication networks may be developed to implement fifth generation (5G) or new radio (NR) technology, sixth generation (6G) technology, and so on. An aspect of such technology includes addressing how radio frequencies and/or other wireless resources may be arranged, allocated, etc., for communications between wireless devices, such as user equipment (UE) device, base stations, etc. Additionally, an aspect of allocating resources may include synchronizing wireless devices to communicate with one another, which may involve a period of signal measurement that is sometimes referred to as a measurement gap.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example wireless network according to one or more implementations described herein.

FIGS. 2A-2C are a diagrams illustrating different examples of a synchronization signal block/physical broadcast channel measurement timing configurations (SMTCs) and measurement gaps according to one or more implementations described herein.

FIG. 3A is a diagram illustrating reconfiguration of measurement gaps in non-terrestrial networks (NTNs) according to one or more implementations described herein.

FIGS. 3B and 3C are diagrams of configured measurement gaps of the NTN of FIG. 3A according to one or more implementations described herein.

FIG. 4 is a diagram of an example method of detecting a collision condition between configured measurement gaps according to one or more implementations described herein.

FIG. 5A is a diagram outlining a selection pattern/scaling technique that may be used in processing overlapping measurement gaps according to one or more implementations described herein.

FIG. 5B is a diagram outlining a prioritization technique that may be used in processing overlapping measurement gaps according to one or more implementations described herein.

FIG. 6 is a diagram of an example method of selecting one or more cells for measurement during a configured measurement gap according to one or more implementations described herein.

FIG. 7 is a diagram of an example of components of a device according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Wireless communication networks may include user equipment (UEs), base stations, and/or other types of wireless devices capable of communicating with one another. An important aspect of mobile wireless networks is enabling wireless devices to synchronize with one another. In 4th Generation (4G) wireless communication networks may implement an approach where reference signals are spread over an entire wireless spectrum for channel estimation. By contrast, 5th Generation (5G) (or New Radio (NR) wireless communication networks may only broadcast a minimum number of cell-specific signals with a known sequence that can be measured by UEs. This 5G signal may include a synchronization signal block (SSB), which may occupy 240 subcarriers (of the frequency domain) and 4 symbols (of the time domain). The SSB may include a primary synchronization signal (PSS), a secondary synchronization signal (SSS), and a physical broadcast channel (PBCH). Additionally, SSBs may be transmitted periodically from each cell, which may involve one of a set of pre-designated or pre-configured transmission patterns.

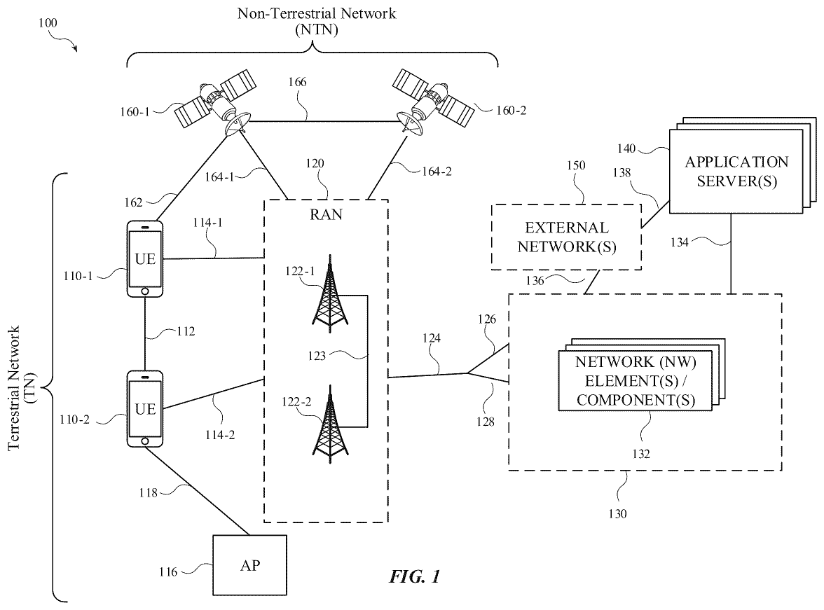

FIG. 1 is an example wireless network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, external networks 150, and satellites 160-1, 160-2, etc. (referred to collectively as “satellites 160” and individually as “satellite 160”). As shown, wireless network 100 may include a terrestrial network (TN) comprising one or more RAN nodes 122 or access points 116 and/or a non-terrestrial network (NTN) comprising one or more satellites 160 (e.g., of a global navigation satellite system (GNSS)) in communication with UEs 110 and RAN 120. RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 2G, 3G, 4G, 5G, WiFi, etc.).

As described below, in some implementations, satellites 160 may operate as base stations (e.g., RAN nodes 122) with respect to UEs 110. Additionally, or alternatively, satellite 160 may include a geosynchronous earth orbit (GEO) satellite, low earth orbit (LEO) satellite, or another type of satellite. Satellite 160 may also, or alternatively, pertain to one or more satellite systems or architectures, such as a global navigation satellite system (GNSS), global positioning system (GPS), global navigation satellite system (GLONASS), BeiDou navigation satellite system (BDS), etc. References herein to a base station, RAN node 122, etc., may involve implementations where the base station, RAN node 122, etc., is a terrestrial network node and also implementations where the base station, RAN node 122, etc., is a non-terrestrial network (NTN) node (e.g., satellite 160). Additional details about the wireless network 100 are described below.

To facilitate radio resource management, a RAN node 122 configures a UE 110 with measurement timing communication windows and measurement gaps during which measurements of SSBs transmitted by selected neighboring cells are measured. When a satellite implements a neighboring cell to be measured, the time at which satellite SSBs is received by a UE can change rapidly.

Radio resource management (RRM) is performed by a wireless network to ensure channels, frequencies ranges, beams, and network infrastructure are used appropriately given the constraints of the overall system and capabilities of individual devices and changing needs or requirements of devices. An example of RRM may include switching beams or cells or activating/deactivating/changing SCGs or SCells for one or more UEs. Each cell in the network transmits RRM reference signals (RS) (e.g., SSBs) on a physical broadcast channel (PBCH) for use in RRM measurements.

A UE participates in RRM by measuring SSBs from active serving cells and selected neighboring cells as configured by the network. The UE reports the measurements to the network (e.g., by way of measurement reports sent to a serving cell). A frequency carrier or frequency layer (these terms are used interchangeably) of a cell may be within a same frequency band as a serving cell for the UE in which case the RRM measurement made by the UE is an intra-frequency measurement. When the frequency layer from a neighboring cell is not within the same frequency band as the cell to which the UE is connected, the RRM measurement is an inter-frequency measurement.

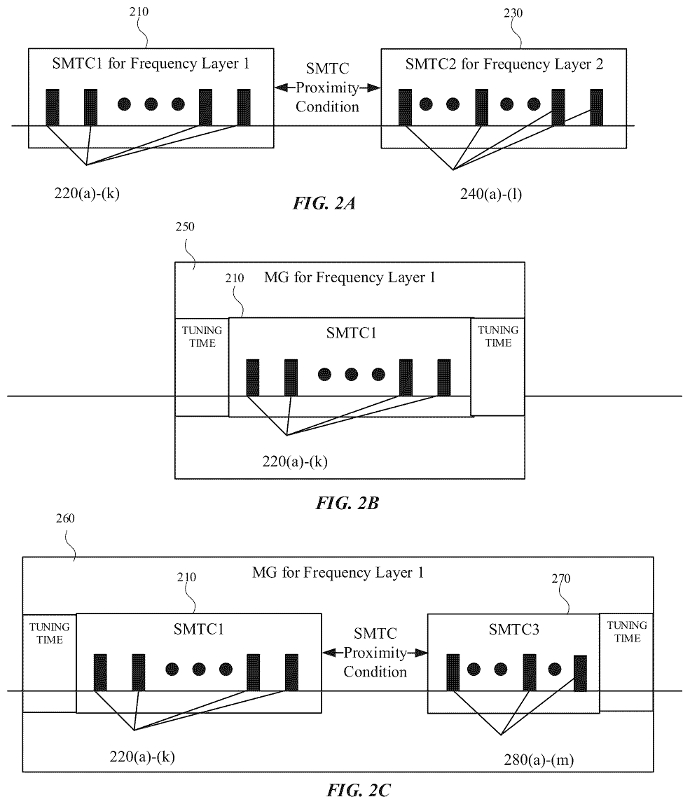

With intra-frequency measurements, the RF chain of the UE may not need to be tuned to receive the RRM-RS, in which case the RRM measurement process does not interrupt normal operation of the UE (e.g., the sending/receiving of data from the serving cell(s)). Referring to FIG. 2A, for each frequency layer to be measured for RRM purposes by the UE, the network configures at least one SSB/PBCH measurement timing configuration (SMTC). In the example of FIG. 2A, two SMTCs are configured, SMTC1 210 for frequency layer 1 and SMTC2 230 for frequency layer 2. Each SMTC specifies a period, offset, and duration of time during which a UE measures SSBs from cells transmitting SSBs in the frequency layer. For example, during SMTC1 210, the UE is configured to measure SSBs 220(a)-(k) and during SMTC2 230 the UE is configured to measure SSBs 240(a)-(l)). In one example, an SMTC is configured as part of an RRC Connection Reconfiguration message and each SMTC is configured in a measTimingConfig-r15 field of a MeasObjectNR IE which specifies details for measuring a specific frequency layer. Thus, generally speaking an SMTC may include configurations for measuring multiple RRM-RS (e.g., SSBs) that are all transmitted on the same frequency layer by respective multiple cells.

When a UE is configured with more than one SMTC, an SMTC proximity condition is used to specify a minimum distance (in terms of time) that, in a proper configuration, should exist between adjacent configured SMTCs. The SMTC proximity condition may be, for example, a predetermined number of slots, symbols, seconds, and so on. The SMTC proximity condition may be dynamically configurable by the network. The UE is not expected to perform measurements in both SMTCs when the SMTC proximity condition is not met. The UE may take any number of actions in response to being configured with “colliding” SMTCs that do not have sufficient time (i.e., less than the SMTC proximity condition) between them. The UE may ignore one of the SMTCs, signal an error condition or an invalid configuration to the network, or take any other appropriate action.

Referring to FIG. 2B, when the RRM-RS are in a different frequency layer (inter-frequency) or even the same frequency layer (intra-frequency) but from a different direction or using a different receive beam, the UE will need to tune its RF chain to receive the RRM-RS and then re-tune the RF chain to the frequency layer of the serving cell(s) to resume communication. The UE is unable to send or receive signals from the serving cell(s) during the period in which the UE is not tuned to the frequency layer of the serving cell(s). When a UE is to make measurements of RRM-RS that will require tuning, the network configures the UE with one or more measurement gaps during which the UE is to receive and measure these RRM-RS signals. During these measurement gaps, the network does not schedule serving cell transmissions to the UE nor does the UE transmit signals to the serving cell(s).

In one example, the measurement gaps are configured by way of a radio resource control (RRC) Connection Reconfiguration message, and in particular by a MeasGapConfig information element (IE) that specifies a measurement gap length (MGL), a measurement gap repetition period (MGRP), and a gapOffset IE that defines the start of the configured measurement gaps relative to the start of the radio frame with system frame number (SFN) equal to 0. To minimize the disruptions caused by RRM-RS measurements, the network configures measurement gaps to be as short as practical while allowing the UE to measure all the different RRM-RS from the neighboring cells (including RF tuning time for tuning to the configured frequency layer).

The length of the measurement gap is determined based on the number and periodicity of the RRM-RS to be measured in addition to a margin period allocated for tuning or tuning time, which may be assumed to be, for example, 0.5 ms when measuring an RRM-RS in a frequency layer within frequency range 1 (FR1) (below 7.125 Ghz) or 0.25 ms when measuring an RRM-RS in a frequency layer within frequency range 2 (FR2) (above 7.125 GHz). As shown in FIG. 2B, a measurement gap 250 is configured for making measurements in frequency layer 1 that require the UE to tune to measure the SSBs 220(a)-(k) as configured by SMTC1 210. The length of the measurement gap is configured to cover the duration of the SMTC1 210 and tuning times before and after SMTC1 210.

As shown in FIG. 2C, the same measurement gap may include multiple SMTCs for the same frequency layer. The different SMTCs may be configured, for example, by different cells. To conserve tuning time, the network may include SMTCs on the same frequency layer in the same measurement gap. FIG. 2C illustrates a measurement gap 260 configured to cover measurements configured by SMTC1 210 and SMTC3 270, where SMTC3 270 is configured for measuring SSBs 280(a)-(m). Within the measurement gap 260, the SMTC proximity condition is observed between SMTC1 210 and SMTC3 270. Tuning times (e.g., 0.5 ms for FR1 or 0.25 ms for FR2) are added at the beginning and end of the measurement gap 260 when determining the offset and duration of the measurement gap.

To increase flexibility a UE may be configured with more than one measurement gap. This allows the network to configure different measurement gaps with different offsets, lengths, and periodicity for different groups of RRM-RS.

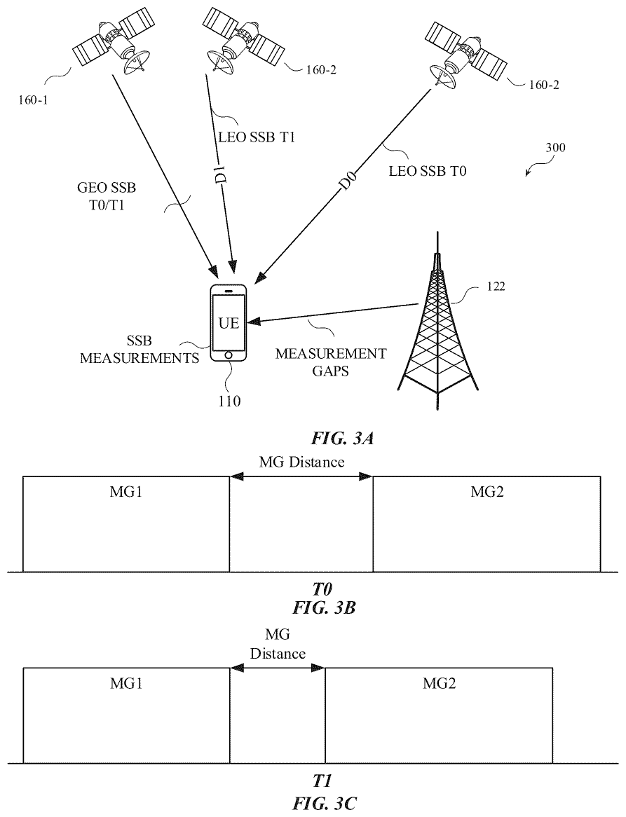

FIG. 3 illustrates a wireless network in which a UE is configured with cells provided by GEO satellite 160-1 and LEO satellite 160-2 as well as cells provided by a terrestrial RAN node or base station 122. In the illustrated example, a cell of the RAN node 122 configures measurement gaps for the UE 110 to measure SSBs from GEO satellite 160-1 and SSBs from LEO satellite 160-2. In other examples an NTN RAN node (e.g., 160-1) may implement the cell that configures measurement gaps. In general, the relative position between the GEO satellite 160-1 and the UE 110 will be changing more slowly than the relative position between the LEO 160-2 due to the LEO satellites high velocity with respect to the earth's surface. Thus, the network may configure separate SMTCs and measurement gaps for measuring SSBs from the GEO satellite 160-1 and SSBs from the LEO satellite 160-2.

The network periodically reconfigures SMTCs based on tentative reception times of the SSBs within the SMTC. The tentative reception time of an SSB is based on a transmission time of the SSB and the propagation delay between the transmitting cell and the UE. When the tentative reception time of an SSB being measured in a configured SMTC moves outside the window defined by the SMTC, the SMTC is reconfigured so that the SMTC covers the tentative reception time of the SSB. When a UE is moving with respect to fixed cells, this UE movement may trigger reconfiguration of an SMTC, and possibly a measurement gap for the SMTC, based on the changing distance and resulting propagation delay between the fixed cell and the UE.

When the UE is configured to measure NTN cells the tentative reception time also changes based on movement of the satellite. The network determines the tentative reception time based on a transmission time of the SSB (e.g., determined based on a GPS clock of the satellite and the configured timing of SSB in terms of slots and system frame numbers) and an estimated propagation delay of the SSB. The propagation delay is a function of an estimated distance between the satellite and a center of a physical footprint of the satellite plus or minus the size of the footprint (to compensate for the possible locations of the UE within the footprint). As the satellite moves relative to its footprint, the distance used to determine propagation delay will increase or decrease, changing the tentative reception time of the satellite's SSB and possibly triggering reconfiguration of an SMTC that is configured for measuring the SSB.

In the example of FIG. 3, the RAN node 122 configures measurement gap MG1 that includes an SMTC (not shown) for measuring SSBs from a cell implemented by the GEO satellite 160-1 and measurement gap 2 MG2 that includes an SMTC (not shown) for measuring SSBs from a cell implemented by the LEO satellite 160-2. MG1 and MG2 are configured with respect to the SMTCs as described in FIG. 2B or FIG. 2C. Referring FIG. 3B, at time T0, the satellite 160-1 transmits an SSB having a tentative reception time that falls within MG1 and the satellite 160-2 transmits an SSB having a tentative reception time that falls within the measurement gap MG2. The end of MG1 and the beginning of MG2 are separated by a distance or time referred to herein as a measurement gap (MG) proximity, which may be defined in terms of seconds, slots, symbols, and so on. In one example, the end of MG1 is determined based on its configured offset and duration and the beginning of MG2 is determined based on its configured offset.

Between times TO and T1, the LEO satellite 160-2 is predicted by the network to move toward the UE (and a center of the satellite's footprint). This will cause a change in the tentative reception time of the LEO satellite SSBs and an SMTC for measuring SSBs from the LEO satellite 160-2 is reconfigured. In response to the reconfigured SMTC, the network reconfigures MG2 as shown in FIG. 3C. At time T1, the satellite 160-1 transmits an SSB having a tentative reception time that falls within MG1 and the satellite 160-2 transmits an SSB having a tentative reception time that falls within the reconfigured measurement gap MG2. The reconfigured MG2 has moved closer to MG1 and the MG proximity at T1 is smaller than the MG proximity between MG1 and MG2 at TO shown in FIG. 3B.

When a cell being measured by a UE for RRM is moving quickly with respect to the UE (e.g., a cell implemented in a low earth orbit (LEO) satellite), the time at which the reference signals from the cell is received by the UE will be changing fairly rapidly (as compared to terrestrial or GEO cells). This means that the network will be reconfiguring measurement gaps more frequently. When a UE has multiple configured measurement gaps, including measurement gaps for cells implemented by NTN network nodes, a newly configured measurement gap may overlap with another measurement gap, causing uncertainty with respect to how the UE should proceed with RRM-RS measurements.

Described herein are systems, methods, and circuitries that provide techniques for determining whether two measurement gaps should be considered as overlapping as well as techniques for determining which measurement gaps of overlapping measurement gaps should be used and which measurement gaps should be discarded. Also described herein are systems, methods, and circuitries for determining which neighboring cells a UE will measure in a measurement gap associated with multiple cells that include NTN cells, and/or multiple SMTCs.

### Detecting Overlapping Measurement Gaps

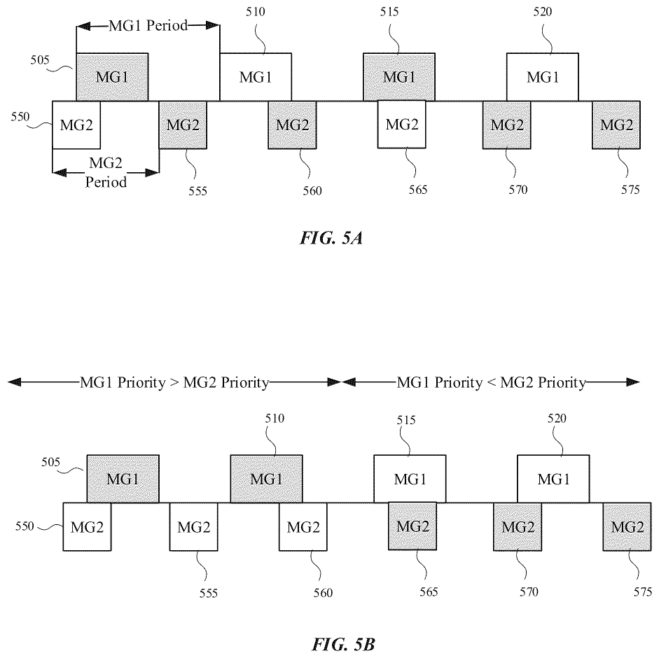

A UE may not be able to perform measurements in both of two overlapping measurement gaps. This is because the SMTCs in the overlapping measurement gaps may be configured to measure frequency layers that would require different tuning by the UE. Thus, it may be beneficial for the UE 110 to be able to determine whether (re) configured measurement gaps overlap based on an MG proximity condition. Once the UE determines that two configured measurement gaps overlap, the UE may select one of the measurement gaps during which to make measurements and optionally take other compensatory actions as will be described below with reference to FIG. 5.

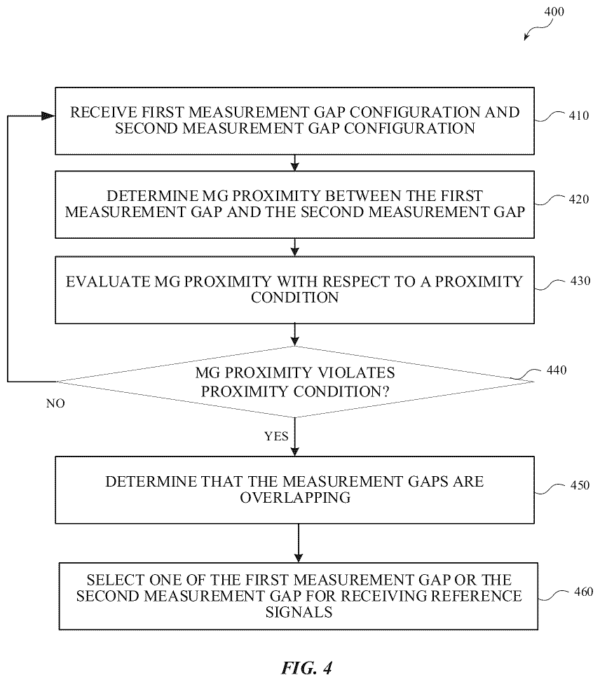

FIG. 4 is a flow diagram outlining an example method 400 that may be performed by a UE to process configured measurement gaps that may be overlapping. At 410, the method includes receiving a first measurement gap configuration that configures a first measurement gap and a second measurement gap configuration that configures a second measurement gap. At 420, an MG proximity is determined between the first measurement gap and the second measurement gap. The MG proximity may be determined based on the configured measurement gap offsets and lengths. At 430, the MG proximity is evaluated with respect to a proximity condition that defines a minimum time between measurement gaps in terms of one of slots, seconds, frames, and so on.

At 440, in response to the MG proximity not violating the proximity condition, the method returns to receiving a next pair of measurement gap configurations at 410. By “violating the proximity condition” it is meant that the MG proximity (e.g., distance between the measurement gaps) is less than the proximity condition. In other words, when the first measurement gap is too close, in time, the second measurement gap, the MG proximity violates the proximity condition and when the first measurement gap is far enough away from, in time, the second measurement gap, the MG proximity does not violate the proximity condition. In response to the MG proximity violating the proximity condition, the method proceeds to 450 and the first measurement gap and the second measurement gap are determined to be overlapping. At 460, one of the first measurement gap or the second measurement gap are selected for measuring reference signals (e.g., SSBs). The UE will not monitor or make measurements configured by the SMTC(s) using the measurement gap that is not selected.

According to a first option, the MG proximity condition may be determined by the UE as a sum of the SMTC proximity condition and a margin period allocated for tuning/re-tuning (e.g., 0.5 ms for FR1 or 0.25 ms for FR2). For example, if the SMTC proximity condition is 4 ms, and both measurement gaps are for FR1, the MG proximity condition could be determined as 4 ms+2 (0.5) ms or 5 ms. If the SMTC proximity condition is 4 ms, and both measurement gaps are for FR2, the MG proximity condition could be determined as 4 ms+2 (0.25) ms or 4.5 ms. If the SMTC proximity condition is 4 ms, and one measurement gap is for FR1 and the other measurement gap is for FR2 the MG proximity condition could be determined as 4 ms+0.5 ms+0.25 ms or 4.75 ms.

According to a second option, the proximity condition may be determined by the UE based on a length of the first measurement gap, the second measurement gap, or both. In general, shorter measurement gaps may be evaluated for potential overlapping using a shorter proximity condition. For example, if one or both of the measurement gaps has a length less than a threshold length, the measurement gap determined based on option 1 or by other means may be reduced by a certain amount or proportion. Thus, in one example, a 5 ms proximity condition determined using option 1 may be reduced by 0.5 ms when both measurement gaps are less than 3 ms.

According to a third option, the proximity condition is determined by the UE based on a type of satellite transmitting reference signals measured during the first measurement gap and the second measurement gap. For example, when the first measurement gap and the second measurement gap are both associated with GEO satellites (e.g., cover SMTCs configured for measuring SSBs from GEO satellites), the proximity threshold may be assigned a first value X. When the first measurement gap is associated with a GEO satellite and the second measurement gap is associated with a LEO satellite, the proximity threshold may be assigned a second value Y, where X is less than and not equal to Y.

According to a fourth option, a value of the proximity condition (e.g., a number of ms) may be signaled to the UE (e.g., by way of downlink control information (DCI)).

According to a fifth option, an indication that a first measurement gap and a second measurement gap are overlapping is signaled to the UE (e.g., by way of DCI).

The UE may be preconfigured with an indication of which of the above five options are to be used for determining the proximity condition. Alternatively the proximity condition option may be dynamically signaled to the UE (e.g., by way of DCI).

### Measurement Gap Selection

Once the UE determines that two configured measurement gaps overlap, the UE selects one of the measurement gaps for making measurements and the other of the measurement gaps to disregard. FIG. 5A is a diagram illustrating an example of a selection pattern technique for selecting one of two overlapping measurement gaps. In FIG. 5A, a series of successive first measurement gaps (MG1) 505, 510, 515, 520 are configured by a first measurement gap configuration. The first measurement gaps have a first measurement gap period, which was specified in the first measurement gap configuration. A series of successive second measurement gaps (MG2) 550, 555, 560, 565, 570, 575 are configured by a second measurement configuration. The second measurement gaps have a second measurement gap period, which was specified in the second measurement gap configuration.

In this example, the UE uses a selection pattern to determine which overlapping MG to measure. The selection pattern indicates a pattern of selecting either the first measurement gap or the second measurement gap over a series of overlapping measurement gaps. The example selection pattern is an alternating selection of MG1 and MG2. According to this pattern, when an MG1 and MG2 overlap, the selection of MG1 or MG2 alternates. Thus, when it is determined that MG1 505 overlaps with MG2 550, MG1 505 is selected for measurement (as indicated by shading) and MG2 550 will not be selected for measurement (indicated by lack of shading). MG2 555 does not overlap and will be selected for measurement. MG1 510 overlaps MG2 560 and MG2 560 is selected due to the selection pattern, and so on.

An indication of the selection pattern to be used may be signaled to the UE (e.g., by way of DCI indicating one of several configured selection patterns). Alternatively, the network may, at each instance of overlapping measurement gaps, select a measurement gap according to a pattern and transmit an indication of either the first measurement gap or the second measurement gap to the UE (e.g., by way of DCI). Alternatively, the UE may choose a selection pattern and signal an indication of the selection pattern to the serving cell. Alternatively, the UE may select a measurement gap according to a pattern and transmit an indication of the selected measurement gap to the serving cell at each instance of overlapping measurement gaps.

To compensate for skipped measurement gaps, the UE may scale measurements reported to the serving cell for the first measurement gap based on a first time that elapses between successive measurements made during successive selected first measurement gaps and scale measurements reported to the serving cell for the second measurement gap based on a second time that elapses between successive measurements made during successive selected second measurement gaps. In the example illustrated in FIG. 5A, due to the selection of MG1 505 and MG1 515 for measuring and the skipping of MG1 510, the UE will scale measurements made during MG1 505 over two MG1 periods instead of one MG1 period. Likewise, due to the selection of MG2 560 and MG2 570 for measuring and the skipping of MG2 565, the UE will scale measurements made during MG2 560 over two MG2 periods instead of one MG2 period.

An example of a prioritization technique for selecting one of overlapping measurement gaps is illustrated in FIG. 5B. In this example, the UE determines a relative priority between overlapping measurement gaps based on a prioritization criteria and selects the measurement gap with the higher priority. In one example, the UE may determine an invalid configuration when a lower priority gap always overlaps a higher priority gap (meaning that the lower priority gap will never be selected for measurement).

In one example, the UE receives a signal from the serving cell indicating the prioritization criteria. The prioritization criteria may be an arbitrary selection of either the first measurement gap by the network or UE for a given time period. Alternatively, the prioritization criteria may indicate that a measurement gap that is configured for measuring reference signals from a first type of satellite (e.g., GEO) has a higher priority than a measurement gap that is configured for measuring reference signals from a second type of satellite (e.g., LEO) or a TN cell. Alternatively, the prioritization criteria may indicate that a measurement gap that is configured for measuring reference signals transmitted in a same frequency layer as a frequency layer on which signals are received from a serving cell have a higher priority than a measurement gap that is configured for measuring reference signals transmitted in a different frequency layer than the frequency layer on which signals are received from a serving cell.

In the example of FIG. 5B, for a first period of time, the first measurement gap has a higher priority according to the priority criteria and during this period, MG1 505 and MG1 510 are selected for measurement and MG2 550, MG2 555, and MG2 560 are not selected for measurement. For a second period of time, the second measurement gap has a higher priority according to the priority criteria and during this period, MG2 565, MG2 570, and MG2 575 are selected for measurement and MG1 515 and MG1 520 are not selected for measurement.

In one example, the network signals an indication of a selection rule to the UE (e.g., by way of DCI). For example, the selection rule may indicate whether UE is to select a measurement gap from overlapping measurement gaps based on either one of the above described selection patterns or one of the above described prioritization criteria.

As can be seen from the foregoing description, a UE may be configured to determine whether two configured measurement gaps overlap and to select one of the overlapping measurement maps to provide predictable processing of measurement gaps that may overlap.

### Limitations on Measurement Gaps and Frequency Layers

With the introduction of NTN, it may be beneficial to specify limitations on an association between a measurement gap and a number of frequency layers or cells that may be measured during the measurement gap. In one example, if both TN and NTN cells are measured during a measurement gap, then no more than a certain integer number X (e.g., 7) of frequency layers may be included in a measurement gap. If only NTN cells are measured during a measurement gap, then no more than a certain integer number Y (e.g., 3) of frequency layers may be included in a measurement gap, where X is greater than Y.

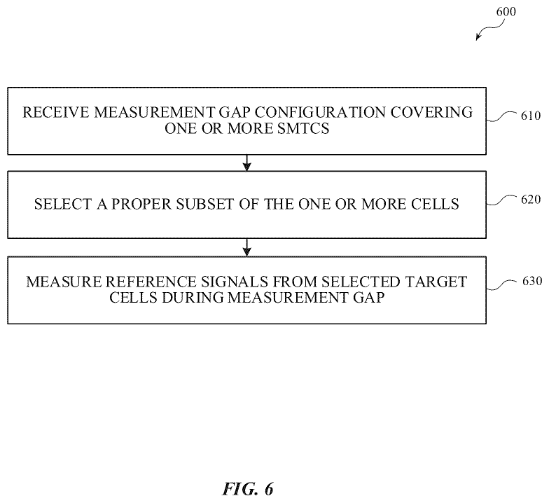

FIG. 6 is a flow diagram outlining a method 600 that may be performed by a UE to process measurement gap configurations that cover multiple frequency layers. At 610, the UE receives a measurement gap configuration. The measurement gap is configured to cover one or more SMTCs. Each SMTC is associated with a frequency layer and one or more target cells. At 620, the UE selects a set of cells from target cells included in the one or more SMTCs based on a selection criteria. At 630 the UE measures reference signals from the selected set of target cells during a measurement gap configured by the measurement gap configuration.

In one example, the selection criteria indicates that target cells associated with a first type of satellite are to be selected and target cells associated with a different type of satellite are not to be selected.

In one example, when the measurement gap covers SMTCs associated with at least two different frequency layers, the selection criteria indicates that target cells associated with a first type of satellite are to be selected for a first frequency layer of the at least two different frequency layers and target cells associated with a different type of satellite are not to be selected for the first frequency layer of the at least two different frequency layers. The selection criteria may indicate that target cells associated with a second type of satellite are to be selected for a second frequency layer of the at least two different frequency layers and target cells associated with a different type of satellite are not to be selected for the second frequency layer of the at least two different frequency layers.

In another example, when the measurement gap covers two or more SMTCs, the selection criteria may indicate that target cells associated with a predetermined number N of the SMTCs are to be selected.

In another example, when the measurement gap covers one or more first SMTCs associated with a first frequency layer and one or more second SMTCs associated with a second frequency layer, the selection criteria may indicate that target cells associated with a first number N of the first SMTCs are to be selected and target cells associated with a second number M of the second SMTCs are to be selected.

### Wireless Network

Returning to FIG. 1, additional details of the wireless network are provided. The systems and devices of example network 100 may operate in accordance with one or more communication standards, such as 2nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or other like having smaller coverage areas, smaller user capacity, or higher bandwidth compared to macrocells.

Some or all of RAN nodes 122 may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein RRC and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may include channels that operate in the frequency range of approximately 400 MHz to approximately 3.8 GHz, whereas the unlicensed spectrum may include the 5 GHz band. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using NR unlicensed, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The LAA mechanisms may be built upon carrier aggregation (CA) technologies of LTE-Advanced systems. In CA, each aggregated carrier is referred to as a component carrier (CC). In some cases, individual CCs may have a different bandwidth than other CCs. In time division duplex (TDD) systems, the number of CCs as well as the bandwidths of each CC may be the same for DL and UL. CA also comprises individual serving cells to provide individual CCs. The coverage of the serving cells may differ, for example, because CCs on different frequency bands will experience different pathloss. A primary service cell or PCell may provide a primary component carrier (PCC) for UL and DL, and may handle RRC and non-access stratum (NAS) related activities. The other serving cells are referred to as SCells, and each SCell may provide an individual secondary component carrier (SCC) for UL and DL. The SCCs may be added and removed as required, while changing the PCC may require UE 110 to undergo a handover. In LAA, eLAA, and feLAA, some or all of the SCells may operate in the unlicensed spectrum (referred to as “LAA SCells”), and the LAA SCells are assisted by a PCell operating in the licensed spectrum. When a UE is configured with more than one LAA SCell, the UE may receive UL grants on the configured LAA SCells indicating different PUSCH starting positions within a same subframe.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

The PDCCH uses control channel elements (CCEs) to convey the control information, wherein a number of CCEs (e.g., 6 or the like) may consists of a resource element groups (REGs), where a REG is defined as a physical resource block (PRB) in an OFDM symbol. Before being mapped to resource elements, the PDCCH complex-valued symbols may first be organized into quadruplets, which may then be permuted using a sub-block interleaver for rate matching, for example. Each PDCCH may be transmitted using one or more of these CCEs, where each CCE may correspond to nine sets of four physical resource elements known as REGs. Four quadrature phase shift keying (QPSK) symbols may be mapped to each REG. The PDCCH may be transmitted using one or more CCEs, depending on the size of the DCI and the channel condition. There may be four or more different PDCCH formats defined in LTE with different numbers of CCEs (e.g., aggregation level, L=1, 2, 4, 8, or 16).

Some implementations may use concepts for resource allocation for control channel information that are an extension of the above-described concepts. For example, some implementations may utilize an extended (E)-PDCCH that uses PDSCH resources for control information transmission. The EPDCCH may be transmitted using one or more ECCEs. Similar to the above, each ECCE may correspond to nine sets of four physical resource elements known as an EREGs. An ECCE may have other numbers of EREGs in some situations.

The RAN nodes 122 may be configured to communicate with one another via interface 123. In implementations where the system is an LTE system, interface 123 may be an X2 interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

As shown, example network 100 may include an NTN that may comprise one or more satellites 160-1 and 160-2 (collectively, “satellites 160”). Satellites 160 may be in communication with UEs 110 via service link or wireless interface 162 and/or RAN 120 via feeder links or wireless interfaces 164 (depicted individually as 164-1 and 164). In some implementations, satellite 160 may operate as a passive or transparent network relay node regarding communications between UE 110 and the terrestrial network (e.g., RAN 120). In some implementations, satellite 160 may operate as an active or regenerative network node such that satellite 160 may operate as a base station to UEs 110 (e.g., as a gNB of RAN 120) regarding communications between UE 110 and RAN 120. In some implementations, satellites 160 may communicate with one another via a direct wireless interface (e.g., 166) or an indirect wireless interface (e.g., via RAN 120 using interfaces 164-1 and 164-2).

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 101, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network nod 122.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 1207 may comprise a local wireless connection, such as a connection consistent with any IEEE 702.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

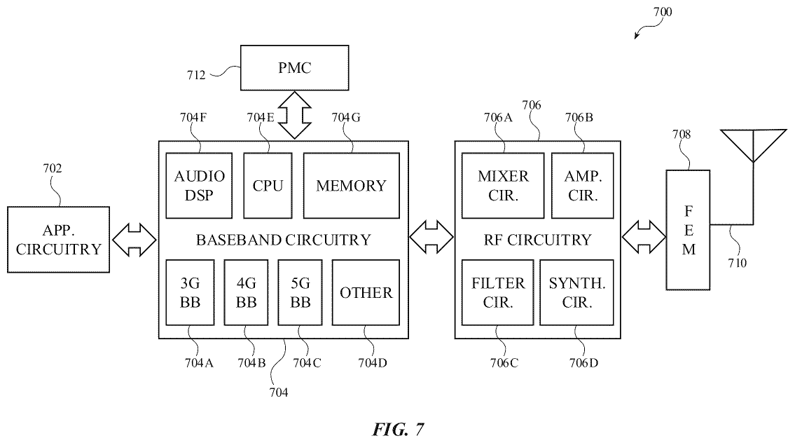

FIG. 7 is a diagram of an example of components of a device according to one or more implementations described herein. The components of the illustrated device 700 can be included in a UE or a RAN node that configures measurement gaps for a UE. In some implementations, the device 700 can include application circuitry 702, baseband circuitry 704, RF circuitry 706, front-end module (FEM) circuitry 708, one or more antennas 710, and power management circuitry (PMC) 712 coupled together at least as shown. In some implementations, the device 700 can include fewer elements (e.g., a RAN node may not utilize application circuitry 702, and instead include a processor/controller to process IP data received from a CN such as 5GC 130 or an Evolved Packet Core (EPC)). In some implementations, the device 700 can include additional elements such as, for example, memory/storage, display, camera, sensor (including one or more temperature sensors, such as a single temperature sensor, a plurality of temperature sensors at different locations in device 700, etc.), or input/output (I/O) interface. In other implementations, the components described below can be included in more than one device (e.g., said circuitries can be separately included in more than one device for Cloud-RAN (C-RAN) implementations).

The application circuitry 702 can include one or more application processors. For example, the application circuitry 702 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 700. In some implementations, processors of application circuitry 702 can process IP data packets received from an EPC.

The baseband circuitry 704 can include circuitry such as, but not limited to, one or more single-core or multi-core processors. The baseband circuitry 704 can include one or more baseband processors or control logic to process baseband signals received (e.g., measurement gap configurations and reference signals from neighboring cells when the device is associated with a UE) from a receive signal path of the RF circuitry 706 and to generate baseband signals (e.g., measurement gap configurations for a UE when the device is associated with a RAN node) for a transmit signal path of the RF circuitry 706. Baseband circuitry 704 can interface with the application circuitry 702 for generation and processing of the baseband signals and for controlling operations of the RF circuitry 706. For example, in some implementations, the baseband circuitry 704 can include a 3G baseband processor 704A, a 4G baseband processor 704B, a 5G baseband processor 704C, or other baseband processor(s) 704D for other existing generations, generations in development or to be developed in the future (e.g., 2G, 6G, etc.). The baseband circuitry 704 (e.g., one or more of baseband processors 704A-D) can handle various radio control functions that enable communication with one or more radio networks via the RF circuitry 706. In other implementations, some or all of the functionality of baseband processors 704A-D can be included in modules stored in the memory 704G and executed via a Central Processing Unit (CPU) 704E. The radio control functions can include, but are not limited to, signal modulation/demodulation, encoding/decoding, radio frequency shifting, etc. In some implementations, modulation/demodulation circuitry of the baseband circuitry 704 can include Fast-Fourier Transform (FFT), precoding, or constellation mapping/de-mapping functionality. In some implementations, encoding/decoding circuitry of the baseband circuitry 704 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, the baseband circuitry 704 can include one or more audio digital signal processor(s) (DSP) 704F. The audio DSPs 704F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 704 and the application circuitry 702 can be implemented together such as, for example, on a system on a chip (SOC).

In some implementations, the baseband circuitry 704 can provide for communication compatible with one or more radio technologies. For example, in some implementations, the baseband circuitry 704 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 704 is configured to support radio communications of more than one wireless protocol can be referred to as multi-mode baseband circuitry.

RF circuitry 706 can enable communication with wireless networks using modulated electromagnetic radiation through a non-solid medium. In various implementations, the RF circuitry 706 can include switches, filters, amplifiers, etc. to facilitate the communication with the wireless network. RF circuitry 706 can include a receive signal path which can include circuitry to down-convert RF signals received from the FEM circuitry 708 and provide baseband signals to the baseband circuitry 704. RF circuitry 706 can also include a transmit signal path which can include circuitry to up-convert baseband signals provided by the baseband circuitry 704 and provide RF output signals to the FEM circuitry 708 for transmission.

In some implementations, the receive signal path of the RF circuitry 706 can include mixer circuitry 706A, amplifier circuitry 706B and filter circuitry 706C. In some implementations, the transmit signal path of the RF circuitry 706 can include filter circuitry 706C and mixer circuitry 706A. RF circuitry 706 can also include synthesizer circuitry 706d for synthesizing a frequency for use by the mixer circuitry 706A of the receive signal path and the transmit signal path. In some implementations, the mixer circuitry 706A of the receive signal path can be configured to down-convert RF signals received from the FEM circuitry 708 based on the synthesized frequency provided by synthesizer circuitry 706D. The amplifier circuitry 706B can be configured to amplify the down-converted signals and the filter circuitry 706C can be a low-pass filter (LPF) or band-pass filter (BPF) configured to remove unwanted signals from the down-converted signals to generate output baseband signals. Output baseband signals can be provided to the baseband circuitry 704 for further processing. In some implementations, the output baseband signals can be zero-frequency baseband signals, although this is not a requirement. In some implementations, mixer circuitry 706A of the receive signal path can comprise passive mixers, although the scope of the implementations is not limited in this respect.

In some implementations, the mixer circuitry 706A of the transmit signal path can be configured to up-convert input baseband signals based on the synthesized frequency provided by the synthesizer circuitry 706D to generate RF output signals for the FEM circuitry 708. The baseband signals can be provided by the baseband circuitry 704 and can be filtered by filter circuitry 706C.

In some implementations, the mixer circuitry 706A of the receive signal path and the mixer circuitry 706A of the transmit signal path can include two or more mixers and can be arranged for quadrature down conversion and up conversion, respectively. In some implementations, the mixer circuitry 706A of the receive signal path and the mixer circuitry 706A of the transmit signal path can include two or more mixers and can be arranged for image rejection (e.g., Hartley image rejection). In some implementations, the mixer circuitry 706A of the receive signal path and the mixer circuitry 1406A can be arranged for direct down conversion and direct up conversion, respectively. In some implementations, the mixer circuitry 706A of the receive signal path and the mixer circuitry 706A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 706 can include analog-to-digital converter (ADC) and digital-to-analog converter (DAC) circuitry and the baseband circuitry 704 can include a digital baseband interface to communicate with the RF circuitry 706.

In some dual-mode implementations, a separate radio IC circuitry can be provided for processing signals for each spectrum, although the scope of the implementations is not limited in this respect.

In some implementations, the synthesizer circuitry 706D can be a fractional-N synthesizer or a fractional N/N+1 synthesizer, although the scope of the implementations is not limited in this respect as other types of frequency synthesizers can be suitable. For example, synthesizer circuitry 706D can be a delta-sigma synthesizer, a frequency multiplier, or a synthesizer comprising a phase-locked loop with a frequency divider.

The synthesizer circuitry 706D can be configured to synthesize an output frequency for use by the mixer circuitry 706A of the RF circuitry 706 based on a frequency input and a divider control input. In some implementations, the synthesizer circuitry 706D can be a fractional N/N+1 synthesizer.

In some implementations, frequency input can be provided by a voltage-controlled oscillator (VCO), although that is not a requirement. Divider control input can be provided by either the baseband circuitry 704 or the applications circuitry 702 depending on the desired output frequency. In some implementations, a divider control input (e.g., N) can be determined from a look-up table based on a channel indicated by the applications circuitry 702.

Synthesizer circuitry 706D of the RF circuitry 706 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 706D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 706 can include an IQ/polar converter.

FEM circuitry 708 can include a receive signal path which can include circuitry configured to operate on RF signals received from one or more antennas 710, amplify the received signals and provide the amplified versions of the received signals to the RF circuitry 706 for further processing. FEM circuitry 708 can also include a transmit signal path which can include circuitry configured to amplify signals for transmission provided by the RF circuitry 706 for transmission by one or more of the one or more antennas 710. In various implementations, the amplification through the transmit or receive signal paths can be done solely in the RF circuitry 706, solely in the FEM circuitry 708, or in both the RF circuitry 706 and the FEM circuitry 708.

In some implementations, the FEM circuitry 708 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 706). The transmit signal path of the FEM circuitry 708 can include a power amplifier (PA) to amplify input RF signals (e.g., provided by RF circuitry 706), and one or more filters to generate RF signals for subsequent transmission (e.g., by one or more of the one or more antennas 710).

In some implementations, the PMC 712 can manage power provided to the baseband circuitry 704. In particular, the PMC 712 can control power-source selection, voltage scaling, battery charging, or DC-to-DC conversion. The PMC 712 can often be included when the device 700 is capable of being powered by a battery, for example, when the device is included in a UE. The PMC 712 can increase the power conversion efficiency while providing desirable implementation size and heat dissipation characteristics.

While FIG. 7 shows the PMC 712 coupled only with the baseband circuitry 704. In other implementations, the PMC 712 may be additionally or alternatively coupled with, and perform similar power management operations for, other components such as, but not limited to, application circuitry 702, RF circuitry 706, or FEM circuitry 708.

In some implementations, the PMC 712 can control, or otherwise be part of, various power saving mechanisms of the device 700. For example, if the device 700 is in an RRC_Connected state, where it is still connected to the RAN node as it expects to receive traffic shortly, then it can enter a state known as Discontinuous Reception Mode (DRX) after a period of inactivity. During this state, the device 700 can power down for brief intervals of time and thus save power.

If there is no data traffic activity for an extended period of time, then the device 700 can transition off to an RRC_Idle state, where it disconnects from the network and does not perform operations such as channel quality feedback, handover, etc. The device 700 goes into a very low power state and it performs paging where again it periodically wakes up to listen to the network and then powers down again. The device 700 may not receive data in this state; in order to receive data, it can transition back to RRC_Connected state.

An additional power saving mode can allow a device to be unavailable to the network for periods longer than a paging interval (ranging from seconds to a few hours). During this time, the device is totally unreachable to the network and can power down. Any data sent during this time incurs a large delay and it is assumed the delay is acceptable.

Processors of the application circuitry 702 and processors of the baseband circuitry 704 can be used to execute elements of one or more instances of a protocol stack. For example, processors of the baseband circuitry 704, alone or in combination, can be used execute Layer 3, Layer 2, or Layer 1 functionality, while processors of the baseband circuitry 704 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

Above are several flow diagrams outlining example methods. In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate is to be construed broadly as identifying an item, value, or quantity, to another communication device. For example, indicate may mean communicating a selection of one option among a set of options, or setting a flag or bit value in a field of a communicated signal (e.g., DCI, UCI).

### Examples

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

Example 1 is baseband processor of a user equipment (UE), including one or more processors configured to receive a first measurement gap configuration configuring a first measurement gap; receive a second measurement gap configuration configuring a second measurement gap; determine a measurement gap (MG) proximity between the first measurement gap and the second measurement gap; and evaluate the MG proximity with respect to a proximity condition, wherein the proximity condition defines a minimum time between measurement gaps. In response to the MG proximity violating the proximity condition, the one or more processors are configured to determine that the first measurement gap and the second measurement gap are overlapping, and in response, select one of the first measurement gap or the second measurement gap for receiving reference signals.

Example 2 includes the subject matter of example 1, including or omitting optional elements, wherein the one or more processors are configured to determine the MG proximity condition based on sum of a synchronization signal block/physical broadcast channel measurement timing configuration (SMTC) proximity condition and a margin period allocated for tuning.

Example 3 includes the subject matter of example 2, including or omitting optional elements, wherein the one or more processors are configured to determine the margin period based on a frequency range in which reference signals measured by the UE during the first measurement gap and the second measurement gap are transmitted.

Example 4 includes the subject matter of example 1, including or omitting optional elements, wherein the one or more processors are configured to determine the proximity condition based on a length of the first measurement gap or the second measurement gap.

Example 5 includes the subject matter of example 1, including or omitting optional elements, wherein the one or more processors are configured to determine the proximity condition based on a type of satellite transmitting reference signals measured during the first measurement gap and the second measurement gap.

Example 6 includes the subject matter of example 1, including or omitting optional elements, wherein the one or more processors are configured to receive a signal indicative of the proximity condition from a serving cell.

Example 7 includes the subject matter of example 1, including or omitting optional elements, wherein the one or more processors are configured to receive a signal indicative of the first measurement gap and the second measurement gap overlapping from a serving cell.

Example 8 includes the subject matter of any one of examples 1-7, including or omitting optional elements, wherein the one or more processors are configured to determine a selection pattern, wherein the selection pattern indicates a pattern of selecting either the first measurement gap or the second measurement gap over a series of overlapping measurement gaps; select the one of the first measurement gap or the second measurement gap based on the pattern; scale measurements reported to a serving cell for the first measurement gap based on a first time that elapses between successive measurements made during successive selected first measurement gaps; and scale measurements reported to the serving cell for the second measurement gap based on a second time that elapses between successive measurements made during successive selected second measurement gaps.

Example 9 includes the subject matter of example 8, including or omitting optional elements, wherein the one or more processors are configured to receive an indication of the selection pattern from a serving cell.

Example 10 includes the subject matter of example 8, including or omitting optional elements, wherein the one or more processors are configured to select the selection pattern; and report the selected pattern to the serving cell.

Example 11 includes the subject matter of example 8, including or omitting optional elements, wherein the one or more processors are configured to select the selection pattern; and report the selected measurement gap to the serving cell.

Example 12 includes the subject matter of any one of examples 1-7, including or omitting optional elements, wherein the one or more processors are configured to receive an indication of either the first measurement gap or the second measurement gap from a serving cell; select the indicated measurement gap; scale measurements reported to the serving cell for the first measurement gap based on a first time that elapses between successive measurements made during successive selected first measurement gaps; and scale measurements reported to the serving cell for the second measurement gap based on a second time that elapses between successive measurements made during successive selected second measurement gaps.

Example 13 includes the subject matter of any one of examples 1-7, including or omitting optional elements, wherein the one or more processors are configured to cause transmission of an indication of a selected one of the first measurement gap or the second measurement gap to a serving cell; select the indicated measurement gap; scale measurements reported to the serving cell for the first measurement gap based on a first time that elapses between successive measurements made during successive selected first measurement gaps; and scale measurements reported to the serving cell for the second measurement gap based on a second time that elapses between successive measurements made during successive selected second measurement gaps.

Example 14 includes the subject matter of any one of examples 1-7, including or omitting optional elements, wherein the one or more processors are configured to determine a relative priority of the first measurement gap and the second measurement gap based on a prioritization criteria; and select the one of the first measurement gap or the second measurement gap having a higher priority.

Example 15 includes the subject matter of example 14, including or omitting optional elements, wherein the one or more processors are configured to receive the prioritization criteria from a serving cell, wherein the prioritization criteria indicates either the first measurement gap or the second measurement gap as having a higher priority.

Example 16 includes the subject matter of example 14, including or omitting optional elements, wherein the prioritization criteria indicates that a measurement gap that is configured for measuring reference signals from a first type of satellite has a higher priority than a measurement gap that is configured for measuring reference signals from a second type of satellite.

Example 17 includes the subject matter of example 14, including or omitting optional elements, wherein the prioritization criteria indicates that a measurement gap that is configured for measuring reference signals transmitted in a same frequency layer as a frequency layer on which signals are received from a serving cell have a higher priority than a measurement gap that is configured for measuring reference signals transmitted in a different frequency layer than the frequency layer on which signals are received from a serving cell.

Example 18 includes the subject matter of any one of examples 1-7, including or omitting optional elements, wherein the one or processors are configured to receive a selection rule from a serving cell, wherein the selection rule indicates whether the UE is to select a measurement gap from overlapping measurement gaps based on a either a selection pattern or prioritization criteria; and select one of the first measurement gap or the second measurement gap based on the selection rule.

Example 19 is a processor for a radio access network (RAN) node, including processing circuitry configured to determine a proximity condition, wherein the proximity condition defines a minimum time between measurement gaps, wherein two measurement gaps separated by less than the minimum time are determined to be overlapping measurement gaps. The processing circuitry is configured to identify a first measurement gap and a second measurement gap as overlapping measurement gaps based on the proximity condition; select one of the first measurement gap or the second measurement gap for use by a user equipment (UE); and receive measurement results from the, wherein the measurement results are for a selected measurement gap of the selected first measurement gap or second measurement gap.

Example 20 includes the subject matter of example 19, including or omitting optional elements, wherein the processing circuitry is configured to determine the MG proximity condition based on sum of a synchronization signal block/physical broadcast channel measurement timing configuration (SMTC) proximity condition and a margin period allocated for tuning.

Example 21 includes the subject matter of example 20, including or omitting optional elements, wherein the processing circuitry is configured to determine the margin period based on a frequency range in which reference signals measured by the UE during the overlapping measurement gaps are transmitted.

Example 22 includes the subject matter of example 19, including or omitting optional elements, wherein the processing circuitry is configured to determine the proximity condition based on a length of the overlapping measurement gaps.

Example 23 includes the subject matter of example 19, including or omitting optional elements, wherein the processing circuitry is configured to determine the proximity condition based on a type of satellite transmitting reference signals measured during the overlapping measurement gaps.

Example 24 includes the subject matter of example 19, including or omitting optional elements, wherein the processing circuitry is configured to cause transmission of a signal indicative of the proximity condition to the UE.

Example 25 includes the subject matter of example 19, including or omitting optional elements, wherein the processing circuitry is configured to cause transmission of a signal indicative of a selected measurement gap of the overlapping measurement gaps to the UE.

Example 26 includes the subject matter of any one of examples 19-25, including or omitting optional elements, wherein the processing circuitry is configured to determine a selection pattern, wherein the selection pattern indicates a pattern of selecting either a first measurement gap or a second measurement gap over a series of overlapping measurement gaps; select the one of the first measurement gap or the second measurement gap based on the pattern; process measurements received from the UE for the first measurement gap based on a first time that elapses between successive measurements made during successive selected first measurement gaps; and process measurements received from the UE for the second measurement gap based on a second time that elapses between successive measurements made during successive selected second measurement gaps.

Example 27 includes the subject matter of example 26, including or omitting optional elements, wherein the processing circuitry is configured to cause transmission of an indication of the selection pattern to the UE.

Example 28 includes the subject matter of example 26, including or omitting optional elements, wherein the processing circuitry is configured to receive an indication of the selection pattern from the UE.

Example 29 includes the subject matter of any one of examples 19-25, including or omitting optional elements, wherein the processing circuitry is configured to determine a relative priority of the overlapping measurement gaps based on a prioritization criteria, wherein the overlapping measurement gaps include a first measurement gap and a second measurement gap; and select the one of the first measurement gap or the second measurement gap having a higher priority.

Example 30 includes the subject matter of example 29, including or omitting optional elements, wherein the processing circuitry is configured to cause transmission of the prioritization criteria to the UE, wherein the prioritization criteria indicates either the first measurement gap or the second measurement gap as having a higher priority.

Example 31 includes the subject matter of example 29, including or omitting optional elements, wherein the prioritization criteria indicates that a measurement gap that is configured for measuring reference signals from a first type of satellite has a higher priority than a measurement gap that is configured for measuring reference signals from a second type of satellite.

Example 32 includes the subject matter of example 29, including or omitting optional elements, wherein the prioritization criteria indicates that a measurement gap that is configured for measuring reference signals transmitted in a same frequency layer as a frequency layer on which signals are received from a serving cell have a higher priority than a measurement gap that is configured for measuring reference signals transmitted in a different frequency layer than the frequency layer on which signals are received from a serving cell.

Example 33 includes the subject matter of any one of examples 19-25, including or omitting optional elements, wherein the processing circuitry is configured to determine a selection rule, wherein the selection rule indicates whether the UE is to select a measurement gap from overlapping measurement gaps based on a either a selection pattern or prioritization criteria; and cause transmission of an indication of the selection rule to the UE.

Example 34 is a method for a user equipment (UE), including receiving a first measurement gap configuration configuring a first measurement gap; receiving a second measurement gap configuration configuring a second measurement gap; determining a measurement gap (MG) proximity between the first measurement gap and the second measurement gap; evaluating the MG proximity with respect to a proximity condition, wherein the proximity condition defines a minimum time between measurement gaps; and in response to the MG proximity violating the proximity condition, determining that the first measurement gap and the second measurement gap are overlapping, and in response, selecting one of the first measurement gap or the second measurement gap for receiving reference signals.

Example 35 includes the subject matter of example 34, including or omitting optional elements, including determining the MG proximity condition based on sum of a synchronization signal block/physical broadcast channel measurement timing configuration (SMTC) proximity condition and a margin period allocated for tuning.

Example 36 includes the subject matter of example 34, including or omitting optional elements, including determining the margin period based on a frequency range in which reference signals measured by the UE during the first measurement gap and the second measurement gap are transmitted.

Example 37 includes the subject matter of example 34, including or omitting optional elements, including determining the proximity condition based on a length of the first measurement gap or the second measurement gap.

Example 38 includes the subject matter of example 34, including or omitting optional elements, including determining the proximity condition based on a type of satellite transmitting reference signals measured during the first measurement gap and the second measurement gap.

Example 39 includes the subject matter of example 34, including or omitting optional elements, including receiving a signal indicative of the proximity condition from a serving cell.

Example 40 includes the subject matter of example 34, including or omitting optional elements, including receiving a signal indicative of the first measurement gap and the second measurement gap overlapping from a serving cell.

Example 41 includes the subject matter of any one of examples 34-40, including or omitting optional elements, including determining a selection pattern, wherein the selection pattern indicates a pattern of selecting either the first measurement gap or the second measurement gap over a series of overlapping measurement gaps; selecting the one of the first measurement gap or the second measurement gap based on the pattern; scaling measurements reported to a serving cell for the first measurement gap based on a first time that elapses between successive measurements made during successive selected first measurement gaps; and scaling measurements reported to the serving cell for the second measurement gap based on a second time that elapses between successive measurements made during successive selected second measurement gaps.

Example 42 includes the subject matter of example 41, including or omitting optional elements, including receiving an indication of the selection pattern from a serving cell.

Example 43 includes the subject matter of example 41, including or omitting optional elements, including selecting the selection pattern; and reporting the selected pattern to the serving cell.

Example 44 includes the subject matter of example 41, including or omitting optional elements, including selecting the selection pattern; and reporting the selected measurement gap to the serving cell.

Example 45 includes the subject matter of any one of examples 34-40, including or omitting optional elements, including receiving an indication of either the first measurement gap or the second measurement gap from a serving cell; selecting the indicated measurement gap; scaling measurements reported to the serving cell for the first measurement gap based on a first time that elapses between successive measurements made during successive selected first measurement gaps; and scaling measurements reported to the serving cell for the second measurement gap based on a second time that elapses between successive measurements made during successive selected second measurement gaps.

Example 46 includes the subject matter of any one of examples 34-40, including or omitting optional elements, including causing transmission of an indication of a selected one of the first measurement gap or the second measurement gap to a serving cell; selecting the indicated measurement gap; scaling measurements reported to the serving cell for the first measurement gap based on a first time that elapses between successive measurements made during successive selected first measurement gaps; and scaling measurements reported to the serving cell for the second measurement gap based on a second time that elapses between successive measurements made during successive selected second measurement gaps.

Example 47 includes the subject matter of any one of examples 34-40, including or omitting optional elements, including determining a relative priority of the first measurement gap and the second measurement gap based on a prioritization criteria; and selecting the one of the first measurement gap or the second measurement gap having a higher priority.

Example 48 includes the subject matter of example 47, including or omitting optional elements, including receiving the prioritization criteria from a serving cell, wherein the prioritization criteria indicates either the first measurement gap or the second measurement gap as having a higher priority.

Example 49 includes the subject matter of example 47, including or omitting optional elements, wherein the prioritization criteria indicates that a measurement gap that is configured for measuring reference signals from a first type of satellite has a higher priority than a measurement gap that is configured for measuring reference signals from a second type of satellite.

Example 50 includes the subject matter of example 47, including or omitting optional elements, wherein the prioritization criteria indicates that a measurement gap that is configured for measuring reference signals transmitted in a same frequency layer as a frequency layer on which signals are received from a serving cell have a higher priority than a measurement gap that is configured for measuring reference signals transmitted in a different frequency layer than the frequency layer on which signals are received from a serving cell.

Example 51 includes the subject matter of any one of examples 34-40, including or omitting optional elements, including receiving a selection rule from a serving cell, wherein the selection rule indicates whether the UE is to select a measurement gap from overlapping measurement gaps based on a either a selection pattern or prioritization criteria; and selecting one of the first measurement gap or the second measurement gap based on the selection rule.

Example 52 is a method for performing operations of the processing circuitry of examples 19-33.

Example 53 is non-transitory computer-readable medium having executable instructions stored thereon that, when executed, cause a processor to perform operations of examples 34-51.

Example 54 is non-transitory computer-readable medium having executable instructions stored thereon that, when executed, cause a processor to perform operations of the processing circuitry of examples 19-33.

Example 55 is an apparatus of a UE including the baseband processor of examples 1-18.

Example 56 is a UE including a memory, an RF interface, and the baseband processor of examples 1-18.

Example 57 is a RAN including the processor of examples 19-33.

Example 58 is a RAN including a memory, an RF interface, and the processor of examples 19-33.

Example 59 is a baseband processor of a user equipment (UE), including one or more processors configured to: receive a measurement gap configuration configuring a measurement gap that includes one or more SMTCs, further wherein each SMTC is associated with a frequency layer and one or more target cells; select a set of target cells from the target cells included in the one or more SMTCs based on selection criteria; and measure reference signals from the selected set of target cells during the measurement gap.

Example 60 includes the subject matter of example 59, including or omitting optional elements, wherein the selection criteria indicates that target cells associated with a first type of satellite are to be selected and target cells associated with a different type of satellite are not to be selected.

Example 61 includes the subject matter of example 59, including or omitting optional elements, wherein the measurement gap covers SMTCs associated with at least two different frequency layers; and the selection criteria indicates that target cells associated with a first type of satellite are to be selected for a first frequency layer of the at least two different frequency layers and target cells associated with a different type of satellite are not to be selected for the first frequency layer of the at least two different frequency layers; and target cells associated with a second type of satellite are to be selected for a second frequency layer of the at least two different frequency layers and target cells associated with a different type of satellite are not to be selected for the second frequency layer of the at least two different frequency layers.

Example 62 includes the subject matter of example 59, including or omitting optional elements, wherein the measurement gap covers two or more SMTCs; and the selection criteria indicates that target cells associated with a predetermined number N of the SMTCs are to be selected.

Example 63 includes the subject matter of example 59, including or omitting optional elements, wherein the measurement gap covers one or more first SMTCs associated with a first frequency layer; the measurement gap covers one or more second SMTCs associated with a second frequency layer; and the selection criteria indicates that target cells associated with a first number N of the first SMTCs are to be selected; and target cells associated with a second number M of the second SMTCs are to be selected.

Example 64 is a method for performing operations of the baseband processor of examples 59-63.

Example 65 is non-transitory computer-readable medium having executable instructions stored thereon that, when executed, cause a processor to perform operations of the baseband processor of examples 59-63.

Example 66 is an apparatus of a UE including the baseband processor of examples 59-63.

Example 67 is a UE including a memory, an RF interface, and the baseband processor of examples 59-63.

Example 68 is a RAN including a processor configured to perform operations of the baseband processor of examples 59-63.

Example 69 is a RAN including a memory, an RF interface, and a processor configured to perform operations of the baseband processor of examples 59-63.

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given or particular application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

1. A baseband processor, comprising:
a memory configured to store instructions; and
baseband circuitry coupled to the memory and, when executing the instructions, configured to:
receive a first measurement gap configuration configuring a first measurement gap;
receive a second measurement gap configuration configuring a second measurement gap;
determine a measurement gap (MG) proximity between the first measurement gap and the second measurement gap;
evaluate the MG proximity with respect to a proximity condition, wherein the proximity condition defines a minimum time between measurement gaps; and
in response to the MG proximity violating the proximity condition,
determine that the first measurement gap and the second measurement gap are overlapping, and
in response, select one of the first measurement gap or the second measurement gap for receiving reference signals.

2. The baseband processor of claim 1, wherein the baseband circuitry is configured to determine the MG proximity condition based on sum of a synchronization signal block/physical broadcast channel measurement timing configuration (SMTC) proximity condition and a margin period allocated for tuning.

3. The baseband processor of claim 2, wherein the baseband circuitry is configured to determine the margin period based on a frequency range in which reference signals measured by a UE during the first measurement gap and the second measurement gap are transmitted.

4. The baseband processor of claim 1, wherein the baseband circuitry is configured to determine the proximity condition based on a length of the first measurement gap or the second measurement gap.

5. The baseband processor of claim 1, wherein the baseband circuitry is configured to determine the proximity condition based on a type of satellite transmitting reference signals measured during the first measurement gap and the second measurement gap.

6. The baseband processor of claim 1, wherein the baseband circuitry is configured to receive a signal indicative of the proximity condition from a serving cell.

7. The baseband processor of claim 1, wherein the baseband circuitry is configured to receive a signal indicative of the first measurement gap and the second measurement gap overlapping from a serving cell.

8. The baseband processor of claim 1, wherein the baseband circuitry is configured to
determine a selection pattern, wherein the selection pattern indicates a pattern of selecting either the first measurement gap or the second measurement gap over a series of overlapping measurement gaps;
select the one of the first measurement gap or the second measurement gap based on the pattern;
scale measurements reported to a serving cell for the first measurement gap based on a first time that elapses between successive measurements made during successive selected first measurement gaps; and
scale measurements reported to the serving cell for the second measurement gap based on a second time that elapses between successive measurements made during successive selected second measurement gaps.

9. (canceled)

10. (canceled)

11. (canceled)

12. The baseband processor of claim 1, wherein the baseband circuitry is configured to
receive an indication of either the first measurement gap or the second measurement gap from a serving cell;
select the indicated measurement gap;
scale measurements reported to the serving cell for the first measurement gap based on a first time that elapses between successive measurements made during successive selected first measurement gaps; and
scale measurements reported to the serving cell for the second measurement gap based on a second time that elapses between successive measurements made during successive selected second measurement gaps.

13. The baseband processor of claim 1, wherein the baseband circuitry is configured to
cause transmission of an indication of a selected one of the first measurement gap or the second measurement gap to a serving cell;
select the indicated measurement gap;
scale measurements reported to the serving cell for the first measurement gap based on a first time that elapses between successive measurements made during successive selected first measurement gaps; and
scale measurements reported to the serving cell for the second measurement gap based on a second time that elapses between successive measurements made during successive selected second measurement gaps.

14. The baseband processor of claim 1, wherein the baseband circuitry is configured to:
determine a relative priority of the first measurement gap and the second measurement gap based on a prioritization criteria; and
select the one of the first measurement gap or the second measurement gap having a higher priority.

15. The baseband processor of claim 14, wherein the baseband circuitry is configured to receive the prioritization criteria from a serving cell, wherein the prioritization criteria indicates either the first measurement gap or the second measurement gap as having a higher priority.

16. The baseband processor of claim 14, wherein the prioritization criteria indicates that a measurement gap that is configured for measuring reference signals from a first type of satellite has a higher priority than a measurement gap that is configured for measuring reference signals from a second type of satellite.

17. The baseband processor of claim 14, wherein the prioritization criteria indicates that a measurement gap that is configured for measuring reference signals transmitted in a same frequency layer as a frequency layer on which signals are received from a serving cell have a higher priority than a measurement gap that is configured for measuring reference signals transmitted in a different frequency layer than the frequency layer on which signals are received from a serving cell.

18. The baseband processor of claim 1, wherein the one or processors baseband circuitry is configured to
receive a selection rule from a serving cell, wherein the selection rule indicates whether a UE is to select a measurement gap from overlapping measurement gaps based on a either a selection pattern or prioritization criteria; and
select one of the first measurement gap or the second measurement gap based on the selection rule.

19. A processor for a radio access network (RAN) node, comprising processing circuitry configured to:
determine a proximity condition, wherein the proximity condition defines a minimum time between measurement gaps, wherein two measurement gaps separated by less than the minimum time are determined to be overlapping measurement gaps;
identify a first measurement gap and a second measurement gap as overlapping measurement gaps based on the proximity condition;
select one of the first measurement gap or the second measurement gap for use by a user equipment (UE); and
receive measurement results from the, wherein the measurement results are for a selected measurement gap of the selected first measurement gap or second measurement gap.

20-22. (canceled)

23. A user equipment (UE), comprising:
radio frequency (RF) circuitry;
a memory; and
one or more processors configured to, when executing instructions stored in the memory, cause the UE to
receive, by way of the RF circuitry, a first measurement gap configuration configuring a first measurement gap;
receive, by way of the RF circuitry, a second measurement gap configuration configuring a second measurement gap;
determine a measurement gap (MG) proximity between the first measurement gap and the second measurement gap;
evaluate the MG proximity with respect to a proximity condition, wherein the proximity condition defines a minimum time between measurement gaps; and
in response to the MG proximity violating the proximity condition,
determine that the first measurement gap and the second measurement gap are overlapping, and
in response, select one of the first measurement gap or the second measurement gap for receiving reference signals.

24. (canceled)

25. (canceled)

26. The UE of claim 23, wherein one or more processor are configured to cause the UE to
determine a relative priority of the first measurement gap and the second measurement gap based on a prioritization criteria; and
select the one of the first measurement gap or the second measurement gap having a higher priority.

27. The UE of claim 26, wherein one or more processor are configured to cause the UE to receive the prioritization criteria from a serving cell, wherein the prioritization criteria indicates either the first measurement gap or the second measurement gap as having a higher priority.

28. (canceled)

29. The UE of claim 26, wherein the prioritization criteria indicates that a measurement gap that is configured for measuring reference signals transmitted in a same frequency layer as a frequency layer on which signals are received from a serving cell have a higher priority than a measurement gap that is configured for measuring reference signals transmitted in a different frequency layer than the frequency layer on which signals are received from a serving cell.
